(19) United States
(12) Patent Application Publication
(10) Pub. No.: US 2022/0189329 A1
(43) Pub. Date: Jun. 16, 2022

(54) SYSTEM AND METHOD FOR ASSISTING WITH THE PRUNING OF PLANTS

(71) Applicant: 3D2cut SA, Sierre (CH)

(72) Inventors: Jean-Pierre ROSAT, Cugy (CH); Tommaso MARTIGNON, La Rivière (FR); Massimo GIUDICI, Udine UD (IT); Marco SIMONIT, Cormons GO (IT)

(21) Appl. No.: 17/432,358

(22) PCT Filed: Feb. 28, 2020
(86) PCT No.: PCT/IB2020/051723

§ 371 Date: Aug. 19, 2021

(30) Foreign Application Priority Data
Mar. 7, 2019 (CH) 00274/19

(51) Int. Cl. G09B 5/02; G06N 20/00; G05B 19/4155

(52) U.S. Cl. CPC G09B 5/02; G05B 2219/45106; G05B 19/4155; G06N 20/00

(57) ABSTRACT

The invention relates to a method for assisting in the pruning of a plant (10) implemented by an electronic apparatus (21), comprising the following steps: a. equipping an electronic device (12; 22; 32) comprising a display area (16; 26; 36), and a camera (18; 28; 38); b. taking at least one image of the plant (10) to be pruned using the camera (18; 28; 38) of the electronic device (12; 22; 32); c. using a machine-learning engine (30) previously trained with training data to determine cutting instructions; and d. displaying the cutting instructions on the display area (16; 26; 36) of the electronic device overlaid over the real image of the plant. The invention also relates to a system (40) for assisting in the pruning of a plant which is intended to implement the above method.

### TECHNICAL FIELD

The present invention relates to a system and a method for assisting in the pruning of plants primarily in the fields of viticulture, arboriculture and rose growing. The system and method are implemented by means of an electronic device, for example by means of augmented-reality glasses, a tablet computer or a smartphone.

### PRIOR ART

In the context of viticulture in particular, there is an art to ensuring good fruiting on the vine. Among the skills to be acquired, vine pruning is probably the one on which the quality of the grapes produced is most dependent. The winegrower seeks grape production while avoiding excessive vine length. Pruning serves to regularize and prolong production on the vine. It also allows increased production by substantially decreasing the number of bunches and, consequently, increasing their size. Size is important for health and therefore the conservation of plant capital. Poor pruning will weaken the stock, in addition to inviting devastating diseases, such as Esca in particular. Harvests will thus be more regular from one year to the next.

It is therefore essential that the vine be pruned by a professional in order to maintain optimal plant quality for the longest possible time and for the quality of the grapes produced.

However, in the field of viticulture, the agricultural laborers who carry out pruning, which has to be fast and cost-effective, are rarely trained in the rules of the art, which has a not-insignificant impact on the quality of the grapes produced.

### BRIEF SUMMARY OF THE INVENTION

An aim of the present invention is therefore to provide methods for assisting in the pruning of a plant, suitable in particular for the fields of viticulture, arboriculture and rose growing, but in general for any plant requiring judicious pruning.

To that end, a method is proposed for assisting in the pruning of a plant implemented by an electronic apparatus, comprising the following steps:
a. equipping a subject with an electronic device comprising a display area, and a camera;
b. taking at least one image of the plant to be pruned using the camera, referred to hereinafter as the reference image;
c. using a machine-learning engine previously trained with training data to determine cutting instructions, and
d. displaying the cutting instructions on the display area of the electronic device overlaid over the real image of the plant to be pruned.

In one embodiment, the electronic device is in the form of augmented-reality glasses comprising the camera and lenses comprising the display area.

Of course, the use of augmented reality in the field of agriculture is already known. By way of example, WO2015135786 discloses an assistance system for assisting an operator of an agricultural machine in their working environment. The assistance system includes augmented-reality glasses configured to display information overlaid over the agricultural environment. The types of information displayed may be planning and/or management data, information on the operation of the agricultural machine, information for assisting the operator (help center) and/or training information.

The information displayed on the lenses of the augmented-reality glasses is not, however, intended to assist a farmer in all of the work performed directly in the natural environment.

In one embodiment, the electronic device is in the form of a tablet computer or a smartphone comprising the display area and the camera.

In one embodiment, the training data are in the form of recommended cut marks or points or the coloring of branches that are not to be retained in images comprising reference features representing a signature specific to each plant image from among a series of images of plants of various appearances.

In one embodiment, a series of images of the plant to be pruned are taken using the camera of the electronic device from a plurality of angles in step b. This step is followed by a step of generating a 3D digital model of the plant to be pruned according to the series of images of the plant. Reference features are extracted from the 3D digital model. These reference features represent a signature specific to the plant to be pruned.

In one embodiment, the reference features correspond in particular to the bifurcations of the branches of the plant to be pruned, and preferably to the ends of the branches.

In one embodiment, the machine-learning engine is a neural network. It has been trained using reference features obtained from training images in order to classify the features extracted from the 3D digital model, and then deduce cutting instructions therefrom, for example cutting instructions selected from a cutting database.

It is then possible to display these cutting instructions in augmented reality overlaid over the image of the plant to be pruned as captured by the camera.

In one embodiment, the cutting instructions comprise cut points or marks or coloring of branches that are not to be retained overlaid over the branches of the real plant image and/or explanatory videos/images.

In one embodiment, instructions for moving around the plant to be pruned are displayed on the display area of the electronic device in order to take images of the plant from optimal angles so as to be able to generate the 3D digital model.

In one embodiment, the reference image or the 3D digital model may be transmitted in real time or near-real time to a remote operator. The operator then transmits audio and/or visual cutting instructions to the subject.

In one embodiment, the plant to be pruned is a grapevine plant. In another embodiment, the plant to be pruned may be a rose shrub, a fruit tree such as an apple tree, or any other type of plant that requires judicious pruning.

Another aspect of the invention relates to a system for assisting in the pruning of a plant which is intended to implement the method described above according to its various embodiments.

To that end, the system comprises:
a camera;
an electronic device comprising a display area for displaying, in augmented reality overlaid over an image of the plant captured by the camera, one or more items of cutting information from among the group comprising text, images, videos and/or cut points/marks, and
a machine-learning engine previously trained with training images for recognizing reference features of the plant filmed by the camera and for selecting cutting instructions associated with these reference features.

In one embodiment, the electronic device is in the form of augmented-reality glasses comprising the camera and lenses comprising the display area. The system further comprises a smartphone configured to transmit the data relating to the cutting instructions to the augmented-reality glasses via a wireless interface, in particular via Wi-Fi or Bluetooth, in order to display said instructions on the display area of the augmented-reality glasses.

In one embodiment, the electronic device is in the form of a tablet computer or a smartphone comprising the display area and the camera.

In one embodiment, the machine-learning engine is a neural network.

In one embodiment, the system further comprises an electronic apparatus or a remote processing unit. The electronic apparatus or the remote processing unit comprises a computing unit for generating a 3D digital model.

In one embodiment, the electronic apparatus is a smartphone or a tablet computer.

In one embodiment, an image database and/or an instruction database are stored in a memory of the electronic apparatus or in a memory of the remote processing unit.

In one embodiment, the machine-learning engine is implemented by software executed in a memory of the electronic apparatus or in a memory of the remote processing unit.

In one embodiment, processing of an image captured by a camera is performed by software executed in a memory of the electronic apparatus or in a memory of the remote processing unit.

In one embodiment, a 3D model is obtained on the basis of a plurality of successive images captured by the camera, by means of software executed in a memory of the electronic apparatus or in a memory of the remote processing unit.

In one embodiment, reference features are extracted from one or more images of the plant, or from a 3D model of the plant, by means of software executed in a memory of the electronic apparatus or in a memory of the remote processing unit.

In one embodiment, the remote processing unit is a server configured to transmit the data relating to the cutting instructions to the electronic apparatus via a communication network, for example a cellular telephone network.

Another aspect of the invention relates to a software application for a smartphone for assisting in the pruning of a plant, in particular of a grapevine plant for example. The software application, when it is executed, allows the following operations to be performed:
generating a 3D digital model of a plant on the basis of a series of images of various views of the plant;
extracting reference features from a 3D digital model, the reference features representing a signature specific to the plant to be pruned;
classifying the reference features by means of a machine-learning engine previously trained using reference images; and
selecting cutting instructions according to this classification.

Another aspect of the invention relates to a method for assisting in the pruning of a plant, in particular of a grapevine plant for example, comprising the following steps:
a. equipping a subject with an electronic device comprising a display area, and a camera;
b. filming the plant to be pruned by means of the camera of the electronic device and transmitting the images of the plant in real time to a remote operator; and
c. the operator transmitting instructions for pruning the plant and displaying said instructions on said display area in augmented reality overlaid over the real image of the plant to be pruned.

In one embodiment, the electronic device is in the form of augmented-reality glasses comprising the camera and lenses comprising the display area.

In one embodiment, the augmented-reality glasses are equipped with a microphone and earphones in order to allow two-way communication between the subject and the operator.

In one embodiment, the electronic device is in the form of a tablet computer or a smartphone comprising the display area and the camera.

In one embodiment, the instructions comprise an image selected by the operator from among a series of plant images saved in a database. Each image comprises cutting instructions comprising cut points or marks overlaid over the branches in the real plant image and/or explanatory videos/images.

Another aspect of the invention relates to a method for assisting in the pruning of a plant, in particular of a grapevine plant for example, comprising the following steps:
a. equipping a subject with a smartphone and augmented-reality glasses comprising lenses comprising a display zone;
b. the subject selecting an image by means of the smartphone from among a series of plant images saved in a database in a memory of the smartphone, each image being associated with cutting instructions comprising cut points or marks and/or explanatory videos/images, and
c. transmitting the cutting instructions to the augmented-reality glasses in order to display, on the display area, the cutting instructions in augmented reality overlaid over the real image of the plant to be pruned.

### BRIEF DESCRIPTION OF THE FIGURES

Exemplary implementations of the invention are given in the description which is illustrated by the appended figures, in which:

FIG. 1 illustrates a perspective view of augmented-reality glasses for implementing the system and the method for assisting in the pruning of plants according to one embodiment of the invention;

FIG. 2 illustrates a schematic view of a tablet computer for implementing the system and the method for assisting in the pruning of plants according to another embodiment of the invention;

FIG. 3 illustrates a schematic view of a smartphone for implementing the system and the method for assisting in the pruning of plants according to another embodiment of the invention;

FIG. 4 illustrates a grapevine plant to be pruned;

FIGS. 5a, 5b and 5c illustrate various images of a grapevine plant with instructions on how to prune the grapevine plant;

FIG. 6 illustrates a flowchart of the main steps of the method for assisting in pruning according to one embodiment according to a preferred version of the invention; and

FIG. 7 illustrates a block diagram of a system for implementing the method according to another embodiment of the invention.

### EXEMPLARY EMBODIMENTS OF THE INVENTION

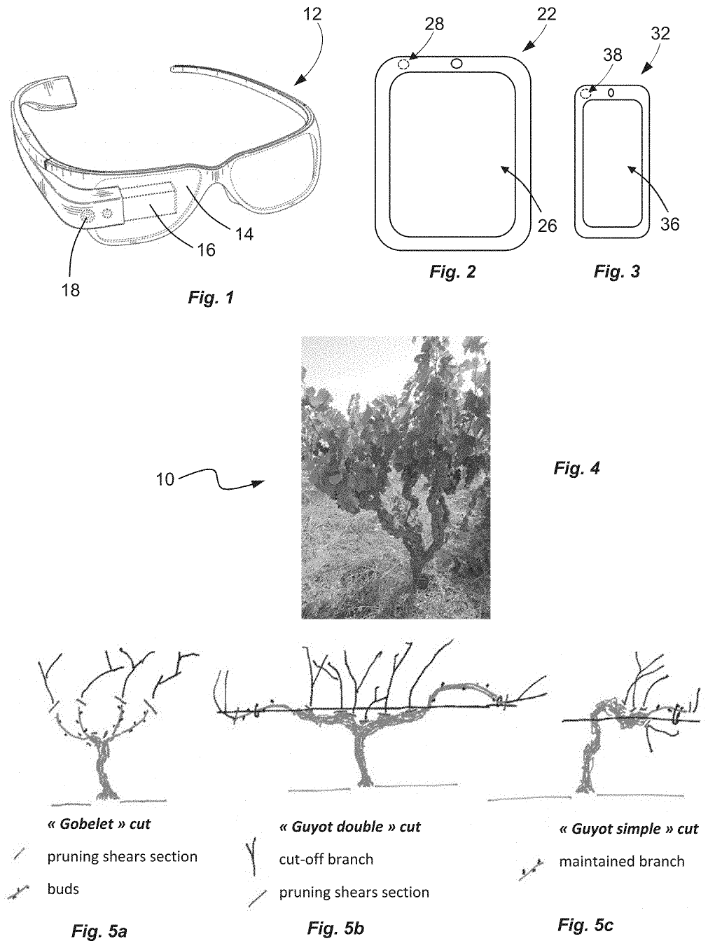

According to one embodiment, the assistance method is suitable for the pruning of a grapevine plant 10 as illustrated in FIG. 4. To that end, a user, for example a person inexperienced with pruning, is equipped with augmented-reality glasses 12 according to the illustrative example of FIG. 1.

The augmented-reality glasses 12 comprise lenses 14 provided with a display area 16 for displaying, in particular, instructions relating to the pruning of the grapevine plant 10 and a camera 18 so as to be able to take an image or series of images of the grapevine plant to be pruned as illustrated in FIG. 4. Advantageously, the augmented-reality glasses 12 may further comprise an accelerometer and preferably a compass (these are not illustrated).

Furthermore, according to one preferred embodiment, not illustrated, the augmented-reality glasses 12 comprise an RGB camera, an infrared camera and a 3D camera. The use of an infrared camera makes it possible to overcome problems with shadows or light. The use of a 3D camera, for example a time-of-flight measurement sensor, makes it possible to obtain, from each frame, information on the position of each pixel along three axes X, Y and Z.

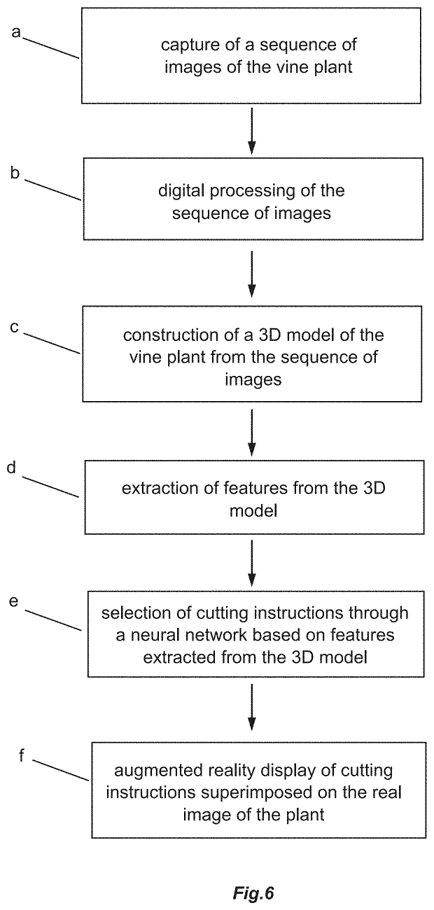

The method according to the invention may preferably comprise the following steps as illustrated in FIG. 6:
a. capturing one or more sequences of images of the grapevine plant 10 using an RGB camera, or preferably using an RGB camera, an infrared camera in order to limit problems with shadows and a 3D camera;
b. transmitting and preliminarily digitally processing the sequence of images in order to correct each image, in particular its brightness, its whiteness, its contrast, its size and in order to overlay the RGB, infrared and 3D images and to extract the foreground and the background so as to retain only the grapevine plant. It is also possible to segment the image of the grapevine plant so as to distinguish, for example, between woody parts (trunk and canes), leaves, bunches, etc.; this makes it possible, for example, to isolate the woody parts and to facilitate subsequent comparison with reference features obtained from plants at a different stage in leaf and fruit development;
C. constructing a 3D digital model of the grapevine plant to be pruned on the basis of the one or more sequences of images while preferably taking into account data from the accelerometer and/or from the compass of the augmented-reality glasses. The 3D digital model may, for example, be obtained by aligning and overlaying the various frames of images obtained by the various RGB, infrared and/or 3D sensors;
d. extracting “features”, referred to hereinafter as reference features, from the 3D digital model, for example the parts of the grapevine plant that correspond, in particular, to the bifurcations of the canes, and/or to the ends of the canes, etc.;
e. transmitting these reference features to a neural network, previously trained with training images comprising only training features and with cutting instructions according to the configuration of the reference features in the image, so as to determine cutting instructions for the grapevine plant to be pruned; and
f. displaying the cutting instructions overlaid over the video image in real time, for example in the form of marks or points on the branches to be cut or explanatory text, images or video.

It should be noted that the training features constitute a signature specific to each plant used for training. These features may, for example, represent points of bifurcation of the branches and ends of the canes of a grapevine plant that has been previously modeled in order to retain only these data so as to decrease the volume of data for each plant.

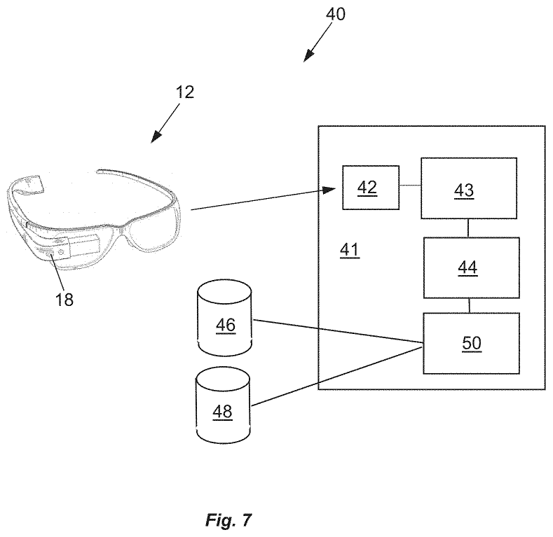

According to FIG. 7, a system 40 for assisting in the pruning of the vine plant comprises the augmented-reality glasses 12 as described above and an electronic apparatus 41. The electronic apparatus 41 comprises a receiver unit 42 for receiving the data constituting the sequence of images transmitted by the augmented-reality glasses 12, a digital processing unit 43 for preliminarily digitally processing the sequence of images (see step b of the method described above), a computing unit 44 (processor) for generating a 3D digital model of the grapevine plant to be pruned on the basis of the sequence of images, an instruction database 48 and a neural network 50 previously trained with reference features obtained from training images corresponding to 3D digital models of a large number of grapevine plants in a database 26.

The neural system 50 is designed to, first, classify the reference features extracted from the image captured using the camera, or from the 3D model generated on the basis of a plurality of images of a sequence, and then, second, deduce associated cutting instructions from this classification. The cutting instructions are then displayed on the display area 16 of the glasses 12 in order to display these instructions in augmented reality overlaid over the image of the grapevine plant captured by the camera. The cutting instructions are, for example, in the form of marks, colors or points on the branches to be cut, in the form of images as illustrated in FIGS. 5a-5c or in the form of explanatory videos. In this exemplary plant, the inexperienced person is thus located in front of the grapevine plant 10 with instructions in their field of view in order to allow them to perform the right actions for optimal pruning of the grapevine plant 10.

The display area 16 of the augmented-reality glasses 12 may display instructions other than those relating to the pruning of the grapevine plant. For example, instructions for moving around the grapevine plant 10 to be pruned may be displayed using data from an accelerometer and a compass integrated into the glasses 12 in order to take the images of the grapevine plant from optimal angles so as to be able to reconstruct the 3D digital model of the grapevine plant to be pruned. The accelerometer and the compass may also be used to determine the position of the camera and the camera axis direction, so that the 3D digital model may be built using various optimal shots.

Advantageously, the machine-learning engine is in the form of a neural network 50 that has been previously trained in order to learn to determine which cutting instructions to display for which plant. To that end, the neural network 50 has been trained with reference features from a large number of 2D or 3D models, each corresponding to a particular grapevine plant and with cutting instructions entered by a specialist for each plant.

In one advantageous embodiment, the electronic apparatus 41 may, for example, be a smartphone in communication with the augmented-reality glasses 12, for example via a communication protocol such as Bluetooth. The smartphone 41 may receive a sequence of images sent by the augmented-reality glasses 12 comprising the reference features of the grapevine plant 10 to be pruned and perform preliminary digital processing operations on the sequence of images received, in particular of the type described above.

The computing power of the smartphone processor is sufficient, first, to generate a 3D digital model of the grapevine plant to be pruned on the basis of the sequence of images and to extract the reference features from the 3D digital model and, second, to perform the classification of these features using the neural network 50.

According to this embodiment, the processor of the smartphone first performs image processing, as described above, on each successive frame of one or more sequences of images, and then uses the various images thus processed to generate a 3D model of the filmed grapevine plant and subsequently to extract the reference features therefrom. These reference features are entered into a neural network which is also embodied as software stored in the memory of the smartphone 41 which makes it possible to classify this model in order to determine the closest training model and/or to select cutting instructions associated with the identified plant model. These cutting instructions are then transmitted by the smartphone 41 to the augmented-reality glasses 12 via a communication protocol such as Bluetooth or Wi-Fi in order to display the cutting instructions on the display area 16 of the glasses 12 in augmented reality overlaid over the real image of the grapevine plant to be pruned. This embodiment has the advantage of providing an autonomous system for assisting in pruning which comprises only the augmented-reality glasses 12 and a conventional smartphone 41.

In the context of this advantageous embodiment, a software application may be downloaded to the smartphone 41 in order to implement the method for assisting in the pruning of a grapevine plant. This software application, when it is executed, allows, in particular, preliminary digital processing of the sequence of images received by the smartphone in order to correct each image, in particular its brightness, its contrast, its size and to extract the foreground and the background so as to retain only the grapevine plant.

In another embodiment, the neural network 50 is embodied as software stored in a memory of a server that comprises one or more processors, the computing power of which is especially suitable for the execution of algorithms for classifying models and for the generation of a 3D digital model on the basis of a series of images transmitted by the augmented-reality glasses 12. The server may also store the instruction databases 48 in a memory.

According to this configuration, the server is configured to communicate with the smartphone 41 or the augmented-reality glasses 12 via a communication network, for example a cellular telephone network. The server may thus receive a sequence of images of the grapevine plant 10 to be pruned transmitted by the augmented-reality glasses 12 or by the smartphone 41 via the cellular telephone network in order to generate the 3D digital model so as to extract the reference features needed to select the cutting instructions on the basis of the one or more images identified by the neural network 30 according to the reference features of the 3D digital model.

The cutting instructions are then transmitted by the server to the augmented-reality glasses 12 via the cellular telephone network in order to display the cutting instructions on the display area 16 of the glasses 12 in augmented reality overlaid over the real image of the grapevine plant to be pruned.

Data compression/decompression software may be used to improve the speed of data transmission between the augmented-reality glasses 12 and the smartphone 41, between the augmented-reality glasses 12 and the server or between the smartphone 21 and the server.

According to another embodiment, the method of assisting in the pruning of a grapevine plant consists in equipping a person inexperienced with pruning with augmented-reality glasses 12 comprising lenses 14 comprising a display area 16. The augmented-reality glasses 12 further comprise a camera 18 for filming and transmitting, in real time, the images of the grapevine plant to be pruned to an operator located remotely who has the knowledge required to be able to guide the inexperienced person.

The operator is provided with a computer unit in order to be able to select, from among a series of images of grapevine plants saved in a database, one or more images resembling the images received in real time, comprising instructions relating to the pruning of the plant shown in the image or each image. One or more images from the database are then transmitted via a communication network to the augmented-reality glasses 12 and displayed on the display area 16 of the lenses 14 of the glasses 12. These may advantageously be equipped with a microphone and earphones in order to allow two-way communication between the inexperienced person and the operator.

According to another embodiment, the method of assisting in the pruning of a grapevine plant consists in equipping a person inexperienced with pruning with a smartphone 41 and augmented-reality glasses 12 comprising lenses 14 comprising a display area 16. The inexperienced person may select an image by means of the smartphone 41 from among a series of images of grapevine plants saved in a database in a memory of the smartphone 41. This selection is made manually and is based on the inexperienced person estimating the resemblance to the appearance of the grapevine plant to be pruned. Each image has cutting instructions which preferably comprise cut points or marks. These images are transmitted from the smartphone 41 to the augmented-reality glasses 12, for example via a communication protocol such as Bluetooth or Wi-Fi, in order to be able to display the cutting instructions on the display area 16 of the glasses 12 in augmented reality overlaid over the real image of the grapevine plant.

According to another embodiment of the invention, a person inexperienced with pruning is equipped with a tablet computer 22 or with a smartphone 32, according to FIGS. 2 and 3, comprising, on one side, a display area 26, 36 and, on the back, a camera 28, 38 so as to be able to take an image or series of images of the grapevine plant to be pruned. Advantageously, the tablet computer 22 or the smartphone 32 may further comprise an accelerometer and preferably a compass (these are not illustrated).

This embodiment has the advantage of decreasing the amount of equipment since the tablet computer 22 or the smartphone 32 comprises the necessary hardware in order to execute, on its own, the various steps illustrated in FIG. 6 so as to display, in augmented reality, cutting instructions overlaid over the real image of the plant.

More particularly, the tablet computer or smartphone comprises a digital processing unit for preliminarily digitally processing the sequence of images of the grapevine plant, a computing unit (processor) for generating a 3D digital model of the grapevine plant to be pruned on the basis of the sequence of images, an instruction database and a neural network previously trained with reference features obtained from training images corresponding to 3D digital models of a large number of grapevine plants in a database.

The tablet computer 22 or the smartphone 32 therefore performs the same functions as the electronic apparatus 41 described above in relation to the augmented-reality glasses 12. The selection of cutting instructions via a neural network on the basis of the features extracted from the 3D model may therefore be directly displayed in augmented reality on the display area of the tablet computer or smartphone overlaid over the real image of the plant.

According to another embodiment, the machine-learning engine is trained on the basis of reference features obtained from 2D training images, annotated by an operator using a labeling code, so as to classify the features extracted from these images taken by the electronic device (e.g. augmented-reality glasses 12, tablet computer 22, smartphone 32) rather than from a 3D digital model, and then deduce cutting instructions therefrom, for example cutting instructions selected from a cutting database.

Of course, the method for assisting in pruning according to the invention is not limited to the field of viticulture and may be applied, in particular, to the field of arboriculture for any type of tree, in particular fruit trees, to the field of landscaping for the pruning of ornamental shrubs or to the field of floristry for the pruning of plants for flowers, in particular roses, etc.

1. A method for assisting in the pruning of a plant implemented by an electronic device, comprising the following steps:
a. equipping a subject with an electronic device comprising a display area and a camera;
b. taking at least one image of the plant to be pruned using the camera of the electronic device, referred to hereinafter as the reference image;
c. using a machine-learning engine previously trained with training data to determine cutting instructions according to the reference image, and
d. displaying the cutting instructions on the display area in augmented reality overlaid over the real image of the plant.

2. The method as claimed in claim 1, wherein the electronic device is in the form of augmented-reality glasses comprising the camera and lenses comprising the display area.

3. The method as claimed in claim 1, wherein the electronic device is in the form of a tablet computer or a smartphone comprising the display area and the camera.

4. The method as claimed in claim 1, wherein the training data include recommended cut marks or points associated with reference features representing a signature specific to each plant among a plurality of plants of various appearances.

5. The method as claimed in claim 1, wherein a series of images of the plant to be pruned is taken using the camera of the electronic device from a plurality of angles in step b, which is followed by a step of generating a 3D digital model of the plant to be pruned according to the series of images of the plant, and wherein reference features are extracted from the 3D digital model, the reference features representing a signature specific to the plant to be pruned.

6. The method as claimed in claim 5, wherein at least some of said reference features correspond to the bifurcations of the branches of the plant to be pruned.

7. The method as claimed in claim 5, wherein the machine-learning engine is a neural network designed to, on the one hand, classify the reference features extracted from the 3D digital model and then, on the other hand, determine the cutting instructions associated with these reference features in order to display said cutting instructions in augmented reality overlaid over the captured image of the plant to be pruned.

8. The method as claimed in claim 7, wherein the cutting instructions comprise cut points or marks overlaid over the branches in the plant image and/or explanatory videos/images.

9. The method as claimed in claim 5, wherein instructions for moving around the plant to be pruned are displayed on said display area of the electronic device in order to take images of the plant from optimal angles so as to be able to generate the 3D digital model.

10. The method as claimed in claim 1, comprising the transmission, in real time or near-real time, of the reference image or of the 3D digital model to a remote operator, and the reception, by the subject, of audio and/or visual cutting instructions from this remote operator.

11. The method as claimed in claim 1, wherein the plant is a grapevine plant.

12. A system for assisting in the pruning of a plant which is intended to implement the method as claimed in claim 1, the system comprising:
an electronic device comprising a display area for displaying, in augmented reality overlaid over the real image of the plant, one or more items of information from among the group comprising text, images, videos and cut marks/points, the electronic device further comprising a camera; and
a machine-learning engine previously trained with training data for determining, on the basis of 2D images taken by the electronic device or on the basis of a 3D digital model, cutting instructions.

13. The system as claimed in claim 12, wherein the electronic device is in the form of augmented-reality glasses comprising the camera and lenses comprising the display area, the system further comprising a smartphone configured to transmit the data relating to the cutting instructions to the augmented-reality glasses via a wireless interface, in particular via Wi-Fi or Bluetooth, in order to display said instructions on the display area of the augmented-reality glasses.

14. The system as claimed in claim 12, wherein the electronic device is in the form of a tablet computer or a smartphone comprising the display area and the camera.

15. The system as claimed in claim 12, wherein the machine-learning engine is a neural network.

16. The system as claimed in claim 12, further comprising an electronic apparatus or a remote processing unit, the electronic apparatus or the remote processing unit comprising a computing unit for generating the 3D digital model.

17. The system as claimed in claim 16, wherein said electronic apparatus is integrated into the tablet computer or the smartphone.

18. The system as claimed in claim 16, wherein the machine-learning engine is implemented in the form of software stored in a memory of the electronic apparatus or in a memory of the remote processing unit.

19. The system as claimed in claim 16, wherein the remote processing unit is a server configured to transmit the data relating to the cutting instructions to the electronic device via a communication network, in particular via the Internet.

20. A software application for a smartphone for assisting in the pruning of a plant, in particular of a grapevine plant, the software application, when it is executed, making it possible:
to generate a 3D digital model of a plant on the basis of a series of images of various views of the plant;
to extract reference features from the 3D digital model, the reference features representing a signature specific to the plant to be pruned, and
to identify, according to the reference features, associated cutting instructions.

21. A method for assisting in the pruning of a plant, in particular a grapevine plant, comprising the following steps:
a. equipping a subject with an electronic device comprising a display area and a camera;
b. filming the plant to be pruned by means of the camera of the electronic device and transmitting the images of the plant in real time to a remote operator; and
c. the operator transmitting instructions for pruning the plant and displaying said instructions on said display area.

22. The method as claimed in claim 21, wherein the electronic device is in the form of augmented-reality glasses comprising the camera and lenses comprising the display area.

23. The method as claimed in claim 22, wherein the augmented-reality glasses are equipped with a microphone and earphones in order to allow two-way communication between the subject and the operator.

24. The method as claimed in claim 21, wherein the electronic device is in the form of a tablet computer or a smartphone comprising the display area and the camera.

25. The method as claimed in claim 21, wherein said instructions comprise an image selected, by the operator, from among a series of plant images saved in a database, each image comprising cutting instructions comprising cut points or marks overlaid over the branches of the real plant image and/or explanatory videos/images.

26. A method for assisting in the pruning of a plant, in particular a grapevine plant, comprising the following steps:
a. equipping a subject with a smartphone and augmented-reality glasses comprising lenses comprising a display zone;
b. the subject selecting an image by means of the smartphone from among a series of plant images saved in a database in a memory of the smartphone, each image comprising cutting instructions comprising cut points or marks and/or explanatory videos/images, and
c. transmitting cutting instructions to the augmented-reality glasses in order to display said cutting instructions on the display area in augmented reality overlaid over the real image of the plant to be pruned.
